(19) United States
(12) Patent Application Publication
(10) Pub. No.: US 2001/0009589 A1
(43) Pub. Date: Jul. 26, 2001

(54) Fingerprint recognition system

(76) Inventor: Seung-Ho Lee, Seoul (KR)

Correspondence Address: Jonathan Y. Kang, Esq., Lee & Hong P.C., 11th Floor, 221 N. Figueroa Street, Los Angeles, CA, 90012-2601, US

(21) Appl. No.: 09/768,018

(22) Filed: Jan. 23, 2001

(30) Foreign Application Priority Data
Jan. 24, 2000 (KR) 2000-3250

(51) Int. Cl. G06K 9/00

(52) U.S. Cl. 382/124

(57) ABSTRACT

The present invention discloses a fingerprint recognition system including: a fingerprint recognizer including a) an input part for receiving a first fingerprint information and a first identity information of a person, b) a fingerprint scan part for recognizing the first fingerprint information, c) a first storage for temporarily storing the first fingerprint information and the first identity information, and d) a sender for sending the first fingerprint information and the first identity information of the first storage; and a fingerprint processors including a) a receiver receiving the first fingerprint information and the first identity information from the sender, b) a second storage for storing at least one second fingerprint information and at least one second identity information, the second fingerprint information linked to the second identity information, c) a process part which searches a corresponding second identity information in the second storage by comparing the first and second identity information and verifies identity by comparing the first fingerprint information and the second fingerprint information linked to the searched second identity information, and d) a control part for controlling an outer driving apparatus, wherein the fingerprint processor and fingerprint recognizer are physically separated from each other.

### Cross Reference

This application claims the benefit of Korean Patent Application No. 2000-3250, filed on Jan. 24, 2000 under 35 U.S.C. § 119, the entirety of which is hereby incorporated by reference.

### BACKGROUND OF THE INVENTION

1. Field of the invention

The present invention relates to a fingerprint recognition system, and more particularly to a fingerprint recognition system for use in a door opening system or a security system.

2. Description of Related Art

A fingerprint recognition technique is used for an authentication system such as vehicles, houses, laboratories, computer security system and so on.

FIG. 1 illustrates a conventional fingerprint recognition system. The system has a fingerprint scan part 10 which recognizes fingerprints of a person who wishes to open a door or to access a security system in analogue type and converts the recognized analogue information into a digital signal. The system also has a fingerprint storage 30 for storing fingerprint information of registered persons, a process part 20 which compares the stored fingerprint information and an inputted fingerprint information of the person who wishes to open the door or to access the system security and judges the data match, and a control part 40 for controlling the door open or system security access by order of the process part 20. When the individual's identity is verified by the process part 20, the control part 20 drives a driving apparatus (not shown) for driving the door or the system security. The communication between the control part 40 and the driving apparatus is achieved through a wire or a wireless communication.

By the way, the elements comprising of the fingerprint recognition system is connected to each other through wires. The fingerprint scan part 10 has a plurality of pixels or detecting devices and thus, it is very sensitive to the outer temperature, humidity, impacts, vibrations and contaminants. But fingerprint scan part 10 is exposed to the outside of the device for the system, and thus the operation characteristic of the fingerprint scan part 10 can be affected by the outer environment, and in order to compensate for the problem, the installing cost may be increased. Also, the particles attached on the fingerprint scan part 10 can block the scanning of the correct fingerprint information.

Further, if the fingerprint storage has thousands of the fingerprints, it will take not short time to compare the stored fingerprints and the recognized fingerprint.

There is suggested a portable fingerprint recognition system which can verify an individual's identity. The system or apparatus has incorporated fingerprint sensor and fingerprint storage and sends only “true” or “false” information to the actuator. Thus, it is impossible to use the system for a password of banking account which needs thousands of the fingerprints.

### SUMMARY OF THE INVENTION

It is an object of the invention to provide a fingerprint recognition system which is not affected by the outer environments.

It is another object of the invention to provide a fingerprint recognition system which can process the comparing step of the stored fingerprints and the recognized fingerprint in short time.

It is still another object of the invention to provide a fingerprint recognition system having a potable fingerprint recognizer which can control all controllable apparatuses such as a vehicle, a door, a system security and so on.

In order to achieve the above object, the preferred embodiments of the present invention provide a fingerprint recognition system including: a fingerprint recognizer including a) an input part for receiving a first fingerprint information and a first identity information of a person, b) a fingerprint scan part for recognizing the first fingerprint information, c) a first storage for temporarily storing the first fingerprint information and the first identity information, and d) a sender for sending the first fingerprint information and the first identity information of the first storage; and a fingerprint processors including a) a receiver receiving the first fingerprint information and the first identity information from the sender, b) a second storage for storing at least one second fingerprint information and at least one second identity information, the second fingerprint information linked to the second identity information, c) a process part which searches a corresponding second identity information in the second storage by comparing the first and second identity information and verifies identity by comparing the first fingerprint information and the second fingerprint information linked to the searched second identity information, and d) a control part for controlling an outer driving apparatus, wherein the fingerprint processor and fingerprint recognizer are physically separated from each other.

One of the second identity information can correspond to a plurality of the second fingerprint information. The communication of identity information and the fingerprint information between the fingerprint recognizer and the fingerprint processor can be a RF (Radio Frequency) type. The fingerprint recognizer can have a male port and the fingerprint processor can have a female port, in this case engaging the two ports enables the communication between them. The control part of the fingerprint processor controls the outer driving apparatus by a wireless communication.

Therefore, the fingerprint processor needs not to be exposed to outer environments, leading to minimize the influence of the outer environments. Also, since identity information is based in finding registered or stored fingerprint information, the processing time for verification of the fingerprint can be shorten. Further, the portable fingerprint recognizer can control a plurality of fingerprint processors mounted on different controllable apparatuses such as a vehicle, a door, or a system security.

### BRIEF DESCRIPTION OF THE DRAWINGS

For a more complete understanding of the present invention and the advantages thereof, reference is now made to the following descriptions taken in conjunction with the accompanying drawings, in which like reference numerals denote like parts, and in which:

FIG. 1 is a block diagram illustrating a conventional fingerprint recognition system;

FIG. 2A is a block diagram illustrating a fingerprint recognizer for a fingerprint recognition system according to an embodiment of the invention;

FIG. 2B is a block diagram illustrating a fingerprint processor for a fingerprint recognition system according to the embodiment of the invention;

FIGS. 3A and 3B are a block diagrams of a fingerprint storage of the fingerprint processor for a fingerprint recognition system, each illustrating different storage methods according to the embodiment of the invention; and

FIG. 4 is a flow chart illustrating an operation of the fingerprint recognition system according to the embodiment of the invention.

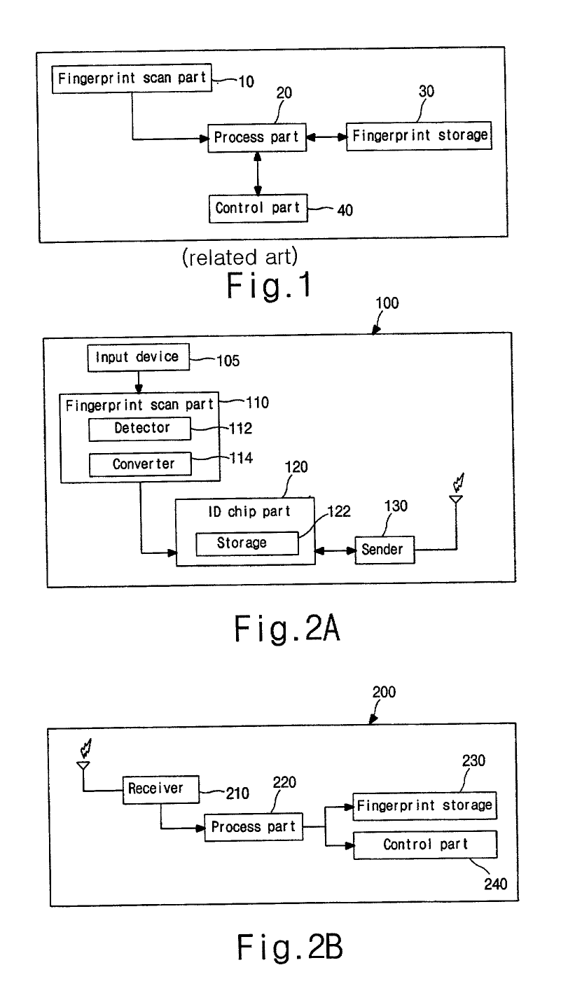

### DETAILED DESCRIPTION OF PREFERRED EMBODIMENTS

Reference will now be made in detail to a preferred embodiment of the present invention, example of which is illustrated in the accompanying drawings.

FIGS. 2A and 2B illustrate an fingerprint recognition system according to an embodiment of the invention.

Generally, fingerprint recognition system is classified into an optical type using an internal light source for scanning fingerprint information, and non-optical type using electric fields and semiconductors for recognizing fingerprint information. The present invention uses the non-optical type. A fingerprint recognition system according to an embodiment of the invention has two physically separated parts, a fingerprint recognizer 100 and a fingerprint processor 200, as respectively shown in FIGS. 2A and 2B.

The fingerprint recognizer 100 includes an input device 105 for receiving fingerprint information and identity information, a fingerprint scan part 110, an identity chip part 120 and a sender 130. The fingerprint scan part 110 has a detector 112 which detects a fingerprint of the person who wishes to unlock the controllable system such as a door or a system security and a converter 114 which converts the detected analogue type information into a digital information. The scan part 110 also proceeds an image enhancement process that reduces noise and enhances ridges.

The identity chip part 120 has a storage 122 which stores the digitalized information and an identity information, for example a password, of the person who provides his/her fingerprint information. The sender 130 sends the stored fingerprint information to the fingerprint processor 200. The identity information can be stored in advance or can be inputted into the storage 122 of the identity chip part 120 using an input device such as a keypad while the fingerprint information is detected by the detector 112.

The fingerprint processor 200 has a receiver 210, a fingerprint-storage 230, a process part 220, and a controller 240. The receiver 210 receives the transmitted fingerprint information from the fingerprint recognizer 100. The fingerprint storage 230 stores a registered identity information and corresponding fingerprint information. The process part 220 compares the registered fingerprint and the inputted fingerprint and judges match of the two-fingerprint information. The controller 240 controls the controllable apparatuses by the order of the process part 220.

The transmission of the fingerprint information from the sender 130 of the fingerprint recognizer 100 to the receiver 210 of the fingerprint processor 200 can use radio frequencies, infrared signal and/or ports. In the radio frequency method, the sender 130 of the fingerprint recognizer 100 includes a radio frequency generator and a battery. In the infrared signal method, the identity and fingerprint information is transmitted on the infrared signal instead of radio frequency signal. In the port method, the fingerprint recognizer 100 has a female port and the fingerprint processor 200 has a male port or vise versa. In this method, by engaging the two ports the communication can be accomplished. Further, an inductor method can be adopted by using a pulse generator. In this method, due to the large amount of the transmitted information the transmission cannot have enough quality, thus the image enhancement comprising reducing noise and enhancing ridges can be processed in the fingerprint scan part 110. In the radio frequency method, the enhancement is preferably processed in the process part 220 of the processor 200.

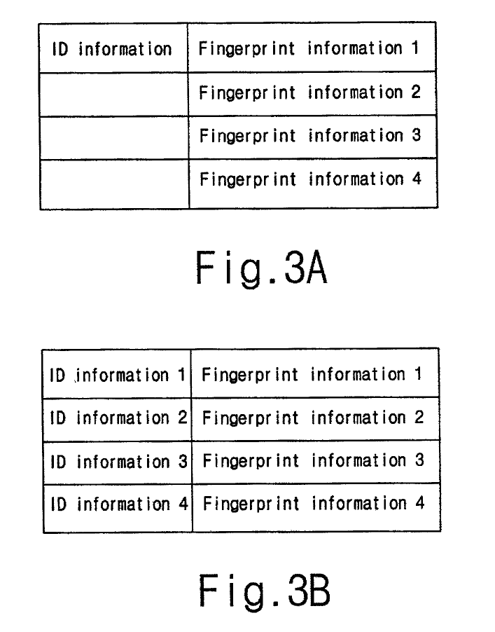

FIGS. 3A and 3B show two different methods of linking identity information and the fingerprint information in the fingerprint storage 230 of the fingerprint processor 200. A plurality of fingerprints for every finger of an individual can be matched to one identity information as shown in FIG. 3A. For another method, every fingerprint of an individual is matched to one identity information, as shown in FIG. 3B. In this case, every registered individual has a plurality of identity information or passwords. Therefore, users can use the fingerprint recognition system even when some of his/her fingers cannot be used for verification.

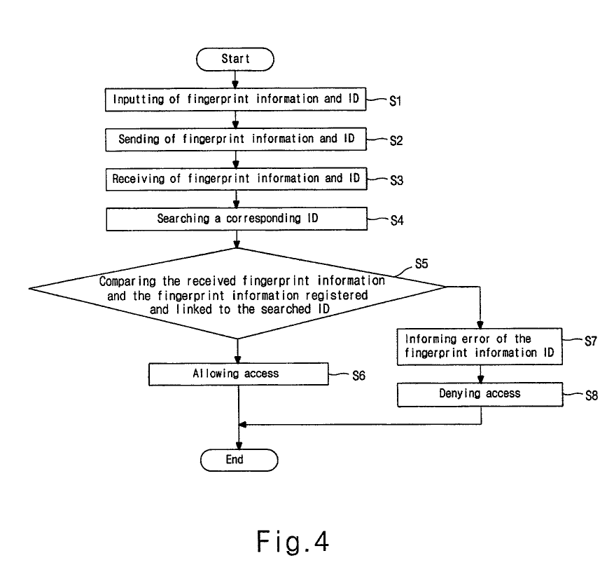

FIG. 4 is a flow chart illustrating operation of the fingerprint recognition system according to an embodiment of the invention.

First, when a person contacts his/her finger to the fingerprint scan part 110 of the fingerprint recognizer 100, the fingerprint is detected and the fingerprint information is digitalized. Before or after the detection the person inputs his/her identity information into the storage of the identity chip part 120. (S1)

Next, the sender sends the digitalized fingerprint information and the input identity information to the receiver 210 of the fingerprint processor 200. (S2)(S3)

Next, the process part 220 of the fingerprint processor 200 searches corresponding identity information in the fingerprint storage 230 having registered identity information in advance with reference to the received identity information. (S4).

Then the process part 220 of the fingerprint processor 200 compares the recognized and received fingerprint and the registered and linked to the searched identity information. (S5).

When the two fingerprints match with each other, the person's identity is verified (S6). If the data do not match, the attempt is rejected and an error message is informed (S7)(S8). The error message can be informed using an LED lamp (not shown).

At this time, an actuator (not shown) for driving the controllable apparatuses is positioned remote from the fingerprint recognition system of the invention. The controller 240 controls the actuator with a digital signal through a wire or wireless communication. For example, when the identity is verified, the digital signal can be “0”, and when the attempt is rejected, the digital signal can be “1”.

According to the invention since the fingerprint sensor or recognizer and the fingerprint processor having thousands of fingerprint information are physically separated, the processor can be mounted on various controllable apparatuses such as houses, laboratories, a bank, a vehicle, a system security and so on. And the fingerprint recognizer can be potable. Thus, using only one fingerprint recognizer, various controllable apparatuses can be controlled or vise versa.

Further, the fingerprint processor need not to be exposed to the outer environments, thus it can be protected by any theft. And since the fingerprint recognizer can be potable, it also need not to be exposed to the outer environments, thus the quality of detection of the fingerprint is not deteriorated.

While the invention has been particularly shown and described with reference to first preferred embodiment s thereof, it will be understood by those skilled in the art that the foregoing and other changes in form and details may be made therein without departing from the spirit and scope of the invention.

What is claimed is:

1. A fingerprint recognition system, comprising:
a fingerprint recognizer including a) an input part for receiving a first fingerprint information and a first identity information of a person, b) a fingerprint scan part for recognizing the first fingerprint information, c) a first storage for temporarily storing the first fingerprint information and the first identity information, and d) a sender for sending the first fingerprint information and the first identity information of the first storage; and
a fingerprint processors including a) a receiver receiving the first fingerprint information and the first identity information from the sender, b) a second storage for storing at least one second fingerprint information and at least one second identity information, the second fingerprint information linked to the second identity information, c) a process part which searches a corresponding second identity information in the second storage by comparing the first and second identity information and verifies identity by comparing the first fingerprint information and the second fingerprint information linked to the searched second identity information, and d) a control part for controlling an outer driving apparatus,
wherein the fingerprint processor and fingerprint recognizer are physically separated from each other.

2. The system of claim 1, wherein the first fingerprint information and identity information is sent from the sender using radio frequencies

3. The system of claim 1, wherein the first fingerprint information and identity information is sent from the sender using infrared signals.

4. The system of claim 1, wherein the second identity information is linked to a plurality of fingerprint information.

5. The system of claim 1, wherein the second identity information is linked to the second fingerprint information one by one.
